(19) United States
(12) Patent Application Publication
(10) Pub. No.: US 2006/0059509 A1
(43) Pub. Date: Mar. 16, 2006

(54) System and method for embedding commercial information in a video bitstream

(76) Inventors: Jau Hsiung Huang, Shindian City (TW); Ho Chao Huang, Shindian City (TW); Dueg Uei Sheng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/939,537

(22) Filed: Sep. 13, 2004

(51) Int. Cl. H04N 7/10

(52) U.S. Cl. 725/32; 715/723

(57) ABSTRACT

Systems and methods for embedding commercial information in a multimedia bitstream to form a hybrid multimedia bitstream having data representing commercial information as well data representing a multimedia signal. The embedded commercial information may be extracted from the multimedia bitstream by an executable module to assist in playing, editing, or processing the multimedia bitstream.

### TECHNICAL FIELD

The present invention relates to systems and methods for processing multimedia bitstreams and, more specifically, relates to systems and methods for embedding commercial information in, and extracting commercial information from, a multimedia bitstream.

### BACKGROUND OF THE INVENTION

The need to analyze, edit, and process digital multimedia content, for example, digital audio or digital video, has become a necessity for those who manipulate multimedia content. Processing and editing multimedia content, at one time, was thought of as a task only performed by professional studios. However, advances in computing hardware and the technology used for editing audio and video has opened the door to non-professionals as well.

For example, a home movie may be recorded using a personal camcorder and transferred to a personal computer for processing, editing, or long-term storage. Digital camcorders, for example, record audio, video, and other information related to the home movie in digital form, such as on tape, computer memory, or a mass storage medium. The home movie may then be transferred to a personal computer using any number of interfaces, and then stored as a digital stream such as multimedia file in a number of common formats such as MPEG-1, MPEG-2, or DV, for example.

Due to algorithm complexity and the relatively large amounts of multimedia data that is typically edited and/or processed, the task of analyzing, processing, and editing multimedia content can take a considerable amount of time, even on powerful computers.

One example of multimedia analysis that may be performed is the detection of commercials interspersed through a sequence of video. Video feeds often include commercials as a means for generating revenue. For a number of reasons, it may be desirable to manipulate the video, (e.g. during playback, editing, or processing, for example) based on the position of the commercials in the video content.

However, to detect commercials in the video, the multimedia bitstream may be analyzed using a variety of algorithms, which may be computationally complex and time consuming. The analysis may, typically after a considerable amount of time, provide an indication of portions of the video signal where commercials may occur. Accordingly, multimedia manipulation software (e.g. software for playing, processing, or editing multimedia bitstreams) may use these indicators to perform various manipulation tasks.

This analysis is typically completed in a vacuum, without the consideration of prior processing or analysis that may have been performed on the multimedia bitstream. Thus, in a subsequent analysis of the multimedia bitstream for these indicators, the multimedia bitstream is completely re-analyzed without consideration of the prior analysis. Additionally, if the multimedia bitstream is analyzed for other purposes, such as in preparation for compressing the multimedia bitstream, the analysis is performed without regard to the prior commercial detection analysis. This may be true even though the same type of analysis (e.g. motion detection, etc.) was performed previously when determining the commercial positions.

Additionally, if the multimedia bitstream is passed to another user or analyzed using different software, as is common, the information from any prior analysis is lost. Thus, any analysis of the multimedia bitstream already performed is repeated. This repeated reanalysis of the multimedia bitstream can be very time consuming and wasteful of computing and personnel resources.

### SUMMARY

The present invention is directed to systems and methods for embedding commercial position information in, and extracting commercial position information from, a multimedia bitstream.

One embodiment of the invention may be described as a method for processing a multimedia bitstream. The method may include providing a multimedia bitstream having multimedia content representing a multimedia signal; analyzing the multimedia bitstream for characteristics of the multimedia signal useful for determining portions of the video signal corresponding to commercial content; determining whether at least one of the portions of the video signal corresponds to commercial content based on the characteristics of the multimedia signal useful for determining portions of the video signal corresponding to the at least one commercial; generating a commercial indicator based on the portions of the video signal corresponding to commercial content; and embedding the commercial indicator into the multimedia bitstream to produce a hybrid multimedia data stream.

Another embodiment of the present invention may be described as a method for processing a multimedia bitstream. The method includes providing a multimedia bitstream having multimedia content representing a multimedia signal, and embedding commercial indicator within the multimedia bitstream, the commercial indicator signifying commercial content in the multimedia signal.

Another embodiment of the present invention may be described as a computer readable medium having a computer program for processing a multimedia bitstream. The computer readable medium includes a first code segment for providing a multimedia bitstream having multimedia content representing a multimedia signal, and a second code segment for embedding a commercial indicator within the multimedia bitstream. The commercial indicator signifying commercial content in the multimedia signal.

Another embodiment of the present invention may be described as a system for processing a multimedia bitstream. The system includes executable module for embedding a commercial indicator within a multimedia bitstream. The commercial indicator signifying commercial content in the multimedia signal.

Another embodiment of the present invention may be described as a system for processing a multimedia bitstream. The system includes an executable module configured to provide a multimedia bitstream having multimedia content representing a multimedia signal. An executable module is also configured to extract commercial a commercial indicator embedded in the multimedia bitstream.

Yet another embodiment of the present invention may be described as a system for processing a multimedia bitstream. The system includes an executable module for extracting information determined from a prior analysis of the multimedia bitstream from the multimedia bitstream, an executable module for determining a commercial indicator by using the extracted information from the prior analysis, and an executable module for embedding the commercial indicator in the multimedia bitstream.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 depicts an exemplary system for embedding commercial information in, and extracting commercial information from, a multimedia bitstream.

FIG. 2 depicts a block diagram of the exemplary computer system of FIG. 1, which includes executable modules for embedding commercial information in, and extracting commercial information from, a multimedia bitstream.

FIG. 3 depicts a block diagram of an embodiment of a system for determining the commercial information to be embedded within a multimedia bitstream.

FIG. 4 depicts an exemplary system for embedding commercial information within a multimedia bitstream.

FIG. 5 depicts a block diagram of an exemplary embodiment of a system for extracting commercial position information from a multimedia bitstream, and for embedding commercial information in a multimedia bitstream.

FIG. 6 depicts an exemplary method for embedding commercial information in a multimedia bitstream.

FIG. 7 depicts yet another exemplary method for embedding commercial position information in, and extracting commercial information from, a multimedia bitstream.

### DETAILED DESCRIPTION

Embodiments of systems and methods for embedding commercial information in, and extracting commercial information from, a multimedia bitstream are described. Commercial information generally refers to information that may be used to determine portions a multimedia bitstream having commercial content. For example, commercial information may include information that indicates the location (directly or inherently) of commercial content in the bitstream. Commercial information may also refer to information (e.g. the results of multimedia bitstream analysis) used to determine the location of commercial content in the bitstream.

A multimedia bitstream may be, for example, any number of types of files, data streams, or digital broadcasts representing any combination of audio, video, data, text, pictures, etc. For example, multimedia streams may take the format of an MPEG-1 bitstream, an MPEG-2 bitstream, an MPEG-4 bitstream, an H.264 bitstream, a 3GPP bitstream, a 3GPP-2 bitstream, Standard-Definition Video (SD-Video) bitstream, a High-Definition Video (HD-Video) bitstream, a Digital Versatile Disc (DVD) multimedia bitstream, a Video Compact Disc (VCD) multimedia bitstream, a High-Definition Digital Versatile Disc (HD-DVD) multimedia bitstream, a Digital Television Video/High-definition Digital Television (DTV/HDTV) multimedia bitstream, an AVI bitstream, a digital video (DV) bitstream, a QuickTime (QT) file, Windows Media Audio (WMA) bitstream, a Windows Media Video (WMV) bitstream, an Advanced System Format (ASF) bitstream, or any number of other popular digital multimedia formats. The above exemplary data streams are merely examples, and it is intended that the system cover any type of multimedia bitstream in its broadest sense.

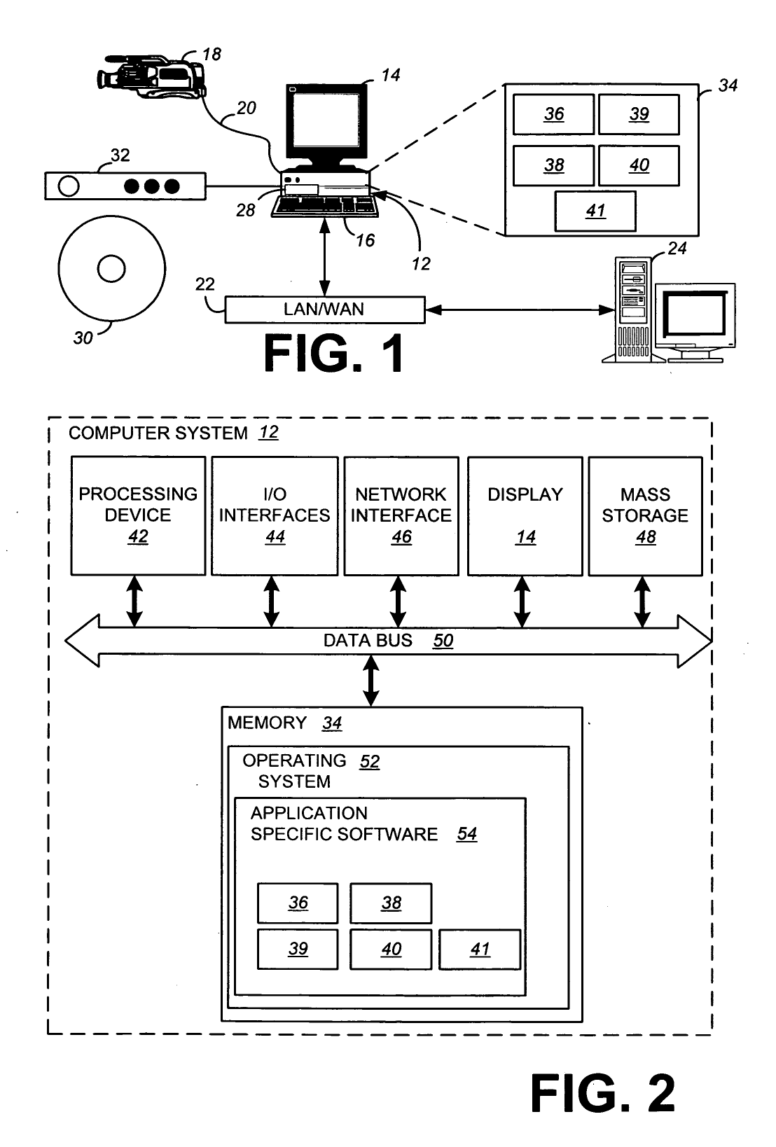

In accordance with certain aspects of a multimedia processing system, FIG. 1 depicts a system for embedding commercial information in, and extracting commercial information from, a multimedia bitstream. The system includes a computer system 12 having a display 14 and user input device 16, which may be a keyboard or a mouse, for example.

A video camera 18 may be coupled to computer system 12 via an electrical cable 20 or a wireless connection. Video camera 18 may, for example, be a digital camcorder which records multimedia content in a variety of digital formats. In this embodiment, electrical cable 20 may be any number of common computer interface cables, such as, but not limited to IEEE-1394 High Performance Serial Bus (Firewire), Universal Serial Bus (USB), a serial connection, or a parallel connection. In this embodiment, a digital multimedia stream may be transferred from video camera 18 to computer system 12 over electrical cable 20.

Computer system 12 may also form a node on a network 22 such as, but not limited to, a LAN or a WAN. In this configuration, multimedia bitstreams may be delivered from a remote server 24 over network 22 to computer system 12. The connection between the remote server 24 and computer system 12 may be any number of standard networking interfaces such as a CAT-5, Firewire, or wireless connection. Computer system 12 may also include optical drive 28 to receive and read optical disk 30, which may have multimedia bitstreams encoded thereon.

In some embodiments, a multimedia bitstream may be downloaded to the computer system 12 using multimedia input device 32 which may be a break-out box, or could be integrated onto an expansion card, either of which are electrically connected to computer system 12.

Multimedia input device 32 may include a variety of standard digital or analog input connections for receiving multimedia signals such as, but not limited to, RCA jacks, a microphone jack, Sony/Philips Digital Interface (S/PDIF) connections, optical connections, coaxial cable, and S-video connections. Multimedia input device 32 may include an analog-to-digital converter for converting analog multimedia to digital multimedia streams. In an embodiment in which multimedia input device 32 is a break-out box external to computer system 12, the box is electrically connected in an number of ways, for example, but not limited to, Firewire, USB, a serial connection, or a parallel connection.

Computer system 12 includes a memory 34, which may be used to store a number of executable modules therein. In some embodiments, any of a multimedia acquisition module 36, commercial detection module 38, multimedia editing module 40, and multimedia processing module 41 may be stored therein. Memory 34 may include a number of other modules which, for example, could be sub-modules of multimedia acquisition module 36, commercial detection module 38, multimedia playback module 39, multimedia editing module 40, and multimedia processing module 41.

In general, multimedia acquisition module 36 functions to acquire a multimedia bitstream. Multimedia acquisition module 36 may acquire a multimedia bitstream in a number of ways, depending on the source. For example, multimedia acquisition module 36 may coordinate the transfer of a multimedia bitstream from video camera 18, optical disc 28, remote server 24, or a mass storage device 48 (FIG. 2) to computer system 12. Multimedia acquisition module 36 also provides the multimedia bitstream to executable modules such as commercial detection module 38, multimedia playback module 39, multimedia editing module 40, and multimedia processing module 41.

Commercial detection module 38 performs the function of analyzing the audio and video content within a multimedia bitstream to determine whether commercial content is located in the portion of the multimedia content being analyzed. Multimedia editing module 40 may perform a number of multimedia editing tasks which may be based on the locations of the commercials in the video. Similarly, multimedia processing module 41 may perform multimedia processing tasks on the multimedia bitstream which may be based on the positions of commercials in the video. Accordingly, multimedia playback module 39, multimedia editing module 40, and multimedia processing module 41 may manipulate the multimedia bitstream based on information indicating the positions of commercials in the video supplied by commercial detection module 38.

In some embodiments, multimedia acquisition module 36, commercial detection module 38, multimedia playback module 39, multimedia editing module 40, and multimedia processing module 41 may be combined into a single module that performs any combination of the tasks performed by each of the modules separately. Thus, any modules or submodules described herein are not limited to existing as separate modules. In reality all modules may operate apart from one another, or could easily be combined as one module. Additionally, it should be understood that each and every module is not essential to perform the systems and methods described herein.

In some embodiments, a user may interact and control the operation of any of multimedia acquisition module 36, commercial detection module 38, multimedia playback module 39, multimedia editing module 40, and multimedia processing module 41 through user input device 16 and a graphical user interface within display 14.

Each of the executable modules, such as multimedia acquisition module 36, commercial detection module 38, multimedia playback module 39, multimedia editing module 40, multimedia processing module 41, and any sub-modules may comprise an ordered listing of executable instructions for implementing logical functions. When the executable modules are implemented in software, it should be noted that the system can be stored on any computer-readable medium for use by, or in connection with, any computer-related system or method. In the context of this document, a computer-readable medium is an electronic, magnetic, optical, or other physical device or apparatus that can contain or store a computer program for use by or in connection with a computer-related system or method. The executable modules can be embodied in any computer-readable medium for use by, or in connection with, an instruction execution system, apparatus, or device, such as a computer-based system, processor-containing system, or other system that can fetch the instructions from the instruction execution system, apparatus, or device and execute the instructions.

In the context of this document, a “computer-readable medium” can be essentially anything that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via optical scanning of the paper or other medium, then compiled, interpreted or otherwise processed in a suitable manner if necessary, and then stored in a computer memory.

FIG. 2 is a block diagram illustrating an exemplary embodiment of computer system 12 on which multimedia acquisition module 36, commercial detection module 38, multimedia playback module 39, multimedia editing module 40, and multimedia processing module 41 may be executed. Generally speaking, the computer system 12 can comprise any one of a wide variety of wired and/or wireless computing devices, such as a desktop computer, portable computer, dedicated server computer, multiprocessor computing device, cellular telephone, personal digital assistant (PDA), handheld or pen based computer, embedded appliance and so forth. Irrespective of its specific arrangement, computer system 12 can, for instance, comprise memory 34, a processing device 42, a number of input/output interfaces 44, a network interface device 46, and mass storage 48, wherein each of these devices are connected across a data bus 50.

Processing device 42 can include any custom made or commercially available processor, a central processing unit (CPU) or an auxiliary processor among several processors associated with the computer system 12, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 34 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 34 typically comprises a native operating system 52, one or more native applications, emulation systems, or emulated applications for any of a variety of operating systems and/or emulated hardware platforms, emulated operating systems, etc. For example, the applications may include application specific software 54, which may include any of the multimedia acquisition module 36, commercial detection module 38, multimedia playback module 39, multimedia editing module 40, and multimedia processing module 41. One of ordinary skill in the art will appreciate that memory 34 can, and typically will, comprise other components which have been omitted for purposes of brevity.

Input/output interfaces 44 provide any number of interfaces for the input and output of data. For example, where the computer system 12 comprises a personal computer, these components may interface with user input device 16, which may be a keyboard or a mouse. Where the computer system 12 comprises a handheld device (e.g., PDA, mobile telephone), these components may interface with function keys or buttons, a touch sensitive screen, a stylist, etc. Display 14 can comprise a computer monitor or a plasma screen for a PC or a liquid crystal display (LCD) on a hand held device, for example.

With further reference to FIG. 2, network interface device 46 comprises various components used to transmit and/or receive data over network 22. By way of example, the network interface device 46 may include a device that can communicate with both inputs and outputs, for instance, a modulator/demodulator (e.g., a modem), wireless (e.g., radio frequency (RF)) transceiver, a telephonic interface, a bridge, a router, network card, etc.)

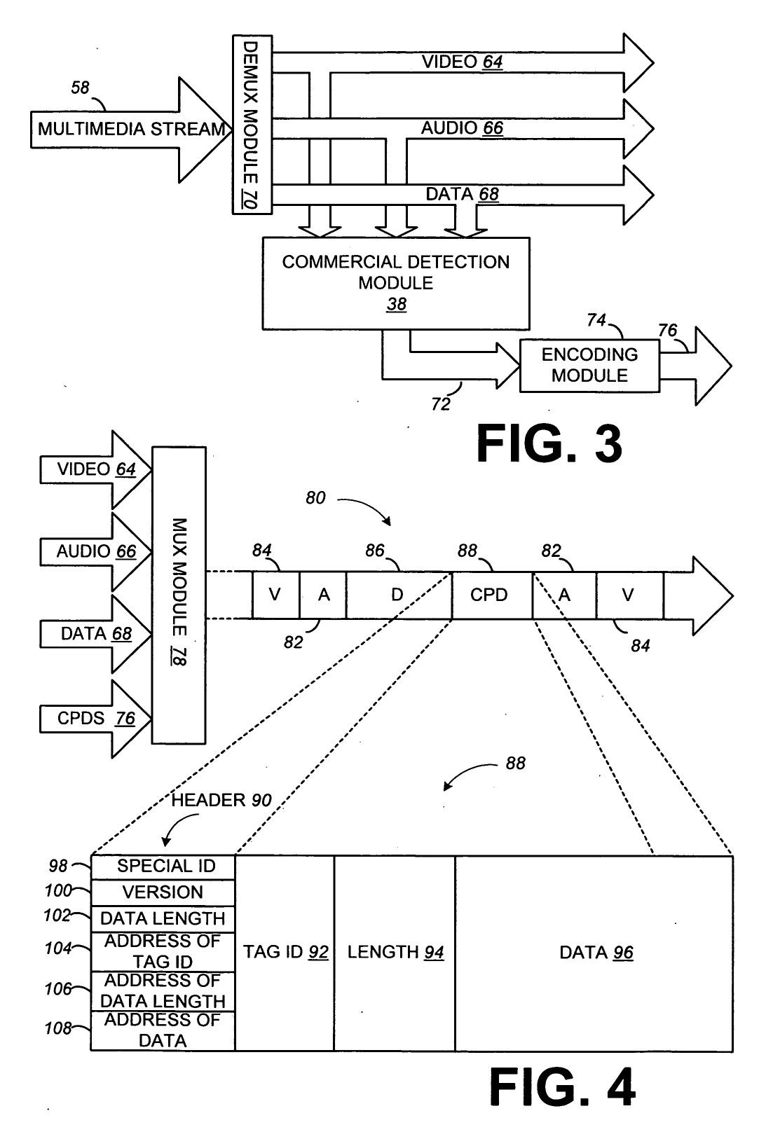

Referring to FIG. 3, an embodiment of a system for determining commercial information to be embedded within a multimedia bitstream is described. In one embodiment, commercial detection module 38 accepts a multimedia stream 58 as input and analyzes the multimedia bitstream 58 to determine characteristics of the multimedia stream useful to determine an indication that a commercial in the video. The analysis may be based upon either, or both of, the audio and video content within the multimedia bitstream 58. These characteristics of the multimedia bitstream may be further analyzed by commercial detection module 38 to determine whether a commercial is located in a particular segment of the video content of the multimedia bitstream.

For example, the type of analysis may include, but is not limited to, any of detecting the motion in the video; detecting a scene change; detecting blanking of the video; determining if the video signal is interlaced; determining if the video signal has been altered; determining if the video signal includes a video watermark; determining if the video signal has been enhanced; determining if the video signal has been blurred; determining positions of video in which faces or eyes are located; determining the level of blockiness in the video; determining frame complexity in the video; detecting skin colors in the video; detecting animation in the video; detecting frame orientation in the video; detecting margins in a video frame; and the detection of a significant change in the color, brightness, or saturation of the video bitstream.

In some cases, analyzing the multimedia bitstream may include analyzing the audio at various positions in the associated video to detect commercial content. For example, the analysis may include detecting the level of volume or energy of the audio, detecting whether there is silence associated with the video signal, or the detecting the audio type (e.g. mono, stereo, dual mono). In some cases the non-commercial content may be presented with one type of audio (e.g. mono audio), and the commercial content may be presented in another type of audio (e.g. stereo), for example.

The various commercial detection analyses listed above are merely examples of those which may be performed to detect commercials in multimedia bitstreams in an automated fashion, and the embodiments of the systems and methods for embedding commercial information into a multimedia bitstream are not limited to the particular type of analysis used.

Each of the analyses used may provide characteristics of the multimedia bitstream at particular locations in the audio and/or video useful to determine the whether commercial content exists within the portion of the analyzed multimedia content. For example, characteristics may include, but are not limited to, a level of motion at an associated position in the video, a sound level at a particular position or portion of the audio associated with the video, a frame complexity at a particular position or portion of the video, an indicator for specifying whether a particular portion of the audio associated with the video contains silence, an indicator for specifying whether a particular portion of the video contains a video watermark, an indicator for specifying whether a particular portion of the video contains animation, an indicator for specifying whether a particular portion of the video contains human faces or eyes, the color of skin at a particular position or portion of video, an indicator for specifying whether a particular portion of the video contains margins (e.g. black margins), an indicator for specifying the frame orientation in a particular position or portion of video, the type of audio associated with a position or portion of the audio, the brightness at a particular position in the video, the color saturation at a particular position in the video, and a position in the video where blanking occurs.

In many cases, it is necessary to compare the characteristics of the audio and/or video in one position of the video with the characteristics of the audio and/or video in other positions of the video in order to detect a degree of change. For example, as explained above, one exemplary characteristic useful to determine the position of a commercial in the video content is the level of sound associated with a segment of video. If the level of sound associated with one segment of video is different from the level of sound associated with another segment of video, this information may be one factor in determining if a commercial is located at a particular position in the multimedia bitstream.

Although in some embodiments only one analysis may be performed, in other embodiments multiple analyses are performed which may more accurately detect commercials within the video. Accordingly, commercial detection module 38 may be configured to further analyze the cumulative results of the various analyses to determine the likelihood that a particular segment of video corresponds to commercial content. In other words, commercial detection module 38 considers the characteristics of the multimedia bitstream at particular locations in the audio and/or video useful to determine the position of a commercial in the video to determine the likelihood that a particular segment of video corresponds to commercial content. The representation of this output may be referred to as commercial indication information, or simply, a commercial indicator.

Thus, the output of the commercial detection module 38 analysis may include a commercial indicator that indicates one or more positions in the video of the multimedia bitstream that corresponds to a commercial. This commercial indicator may be embodied in a variety of formats and the systems and methods herein are not limited to any particular format or representation.

For example, in one embodiment, a commercial indicator may include a starting and ending position in the video of a commercial, for example. Yet in another embodiment, a commercial indicator may simply indicate whether a segment of the multimedia content is likely to include commercial content. That is, in some embodiments the commercial indicator may not specifically indicate a “position” in the multimedia signal where a commercial occurs. Rather, the commercial indicator may be associated with a portion of the multimedia signal. For example, a portion of the multimedia content in the multimedia bitstream may have a flag indicating whether or not the portion includes commercial content. It should be understood that, while not expressly disclosed, the position of the commercial content in the multimedia signal is inherent by its association with a particular segment of multimedia content.

In some embodiments the commercial indicator will also include a likelihood that a portion (or position) of the multimedia content corresponds to commercial content. A likelihood, for example, may be a probability represented as a discrete ranking (e.g. high, medium, or low), a number (e.g. any number between 1-100), or a Boolean representation (e.g. true or false). A position corresponding to the likelihood may be indicated by an offset from the beginning of the bitstream, for example. Accordingly, other executable modules may use the likelihood to set thresholds as to the usage of the commercial indicator.

While embodiments have been described in which commercial detection module 38 detects the portions of the multimedia signal having commercial content using automated algorithms, in some embodiments the commercial indicator may be supplied by the content provider or a viewer of the multimedia content. For example, an executable module such as commercial detection module 38 or multimedia playback module 39 may be configured to provide a graphical user interface within display 14 (FIG. 1) to a viewer of the video content. Through the graphical user interface, the user may indicate (e.g. via a mouse, keyboard, or remote control) particular starting and ending positions in the video content that correspond to commercial content. In some embodiments, the commercial indicator may already be embedded in the multimedia bitstream, or the information indicating the position of commercial content may be supplied in a separate file, signal, or bitstream, for example.

Some embodiments may use a combination of automatic detection and manual indication of a commercial indicator. For example, commercial detection module 38 may analyze the video content and make a best-guess as to the location of commercial content. This best-guess may then be formatted into a human readable format and displayed in the GUI for manual verification and adjustment by a user. Accordingly, while commercial indicators may be acquired in any number of methods, of which only a few have been provided as examples, the systems and methods for embedding commercial indicators within the multimedia bitstream are not limited to any particular method.

Once a commercial indicator is determined, the indicator may then be used by any number of executable modules, for example, to manipulate the multimedia bitstream. Commercial detection module 38, or other executable modules, may also be configured to embed this commercial indicator into the multimedia bitstream. In some embodiments, commercial detection module 38, or other executable modules, may also be configured to embed information determined from the various analyses in the multimedia bitstream. Thus, the characteristics of the multimedia bitstream useful to determine the position of a commercial in the multimedia content may also be embedded in the multimedia bitstream.

Information, such as closed captioning and title information, are sometimes embedded within multimedia bitstreams in a variety of ways, depending on the particular format of the multimedia bitstream. It is contemplated that the commercial information may be embedded in similar ways, and the systems and methods for embedding the commercial information will vary depending on the format of the multimedia file.

The exemplary embodiment of FIG. 3 depicts a multimedia stream 58 in the MPEG-2 format, for example. The MPEG standard, known as ISO-13818-1, is capable of multiplexing multiple streams of multimedia content into a single stream. For example, each of a video stream 64, audio stream 66, and private data stream 68, may coexist within multimedia stream 58.

Video stream 64, audio stream 66, and private data stream 68 are known as “elementary streams.” The MPEG standard allows for the combination of multiple elementary video, audio, or data streams into the same multimedia stream 58. Thus, for example, multimedia stream 58 may include an audio stream for the English language and a second audio stream for the Spanish language. Likewise, multiple video streams may be used. For example, a first video stream could represent video from one camera angle and a second video stream represents video from another angle. Private data stream 68, sometimes known simply as a data stream, is not limited to any single type of data. Data stream 68 may be used, for example, to provide an identification of multimedia stream 58 or may contain data to be decoded by a closed captioning device.

Commercial detection module 38 may consider each of the audio, video, and data streams separately. Therefore, a demultiplexing system, herein DEMUX 70, may be provided to demultiplex, or separate, the elementary streams from multimedia stream 58. Here, multimedia stream 58 is passed into DEMUX 70 and video stream 64, audio stream 66, and private data stream 68 are provided as outputs to commercial detection module 38.

Commercial detection module 38 may analyze the multimedia bitstream to determine a commercial indicator. For example, the video and/or audio content in the bitstream may be analyzed to determine the commercial indicator, as described in detail above. In addition to analyzing one, or both, of the audio and video streams, commercial detection module 38 may read and analyze private data stream 68 to determine the commercial indicator. For example, if data bitstream 68 includes closed captioning text, this text may be analyzed to determine the commercial indicator.

Additionally, commercial detection module 38 may determine if commercial information has been previously embedded within any of the audio, video, or data bitstreams (e.g. within private data stream 68, for example). For example, if a commercial indicator has been previously embedded, commercial detection module 38 may be configured to skip completely, or substantially reduce, further analysis of the multimedia bitstream by extracting the commercial indicator directly.

Likewise, commercial detection module 38 may determine if characteristics of the multimedia stream useful to determine the position of a commercial in the video have been embedded therein. For example, in determining the commercial indicator, commercial detection module 38 may need to analyze the multimedia stream to determine the motion in particular segments of the video. If this motion information is already embedded in private data stream 68, for example, commercial detection module 38 may be configured to use this embedded motion information rather than, or to supplement, analyzing the video and/or audio content in the bitstream. In this respect, time may be saved by not reanalyzing, or substantially reducing, the amount of analyzing required to determine the commercial indicator.

Commercial detection module 38 may also include error checking features, such as using a checksum or other identifying information, to determine if information embedded within the data stream corresponds to a particular version, is reliable information, and/or contains information useful for detecting commercials.

Once commercial detection module 38 has analyzed multimedia stream 58, commercial detection module 38 may provide commercial position data 72 as its output. In the present embodiment, commercial position data 72 represents the commercial indicator determined from analyzing the audio, video, and/or data bitstreams. Commercial position data 72 may be represented in a predetermined format, which may be used directly by other modules such as multimedia playback module 39, multimedia editing module 40, or multimedia processing module 41.

As indicated above, the commercial indicator does not necessarily require a location, address, or offset. Accordingly, though commercial position data 72 uses the term “position” this does not necessarily mean that commercial position data 72 includes a location, address, or offset. Rather, the “position” may be inferred by association with a particular segment of multimedia content.

As depicted in FIG. 3, however, commercial position data 72 may also be passed through an encoding module 74 to convert the format of commercial position data 72 into a bitstream conforming to a variety of standard formats. In other embodiments, encoding module 74 may be integrated within commercial detection module 38, rather than operating as a separate, stand-alone module.

In many cases, it is desirable for encoding module 74 to transform commercial position data 72 into a formatted data stream conforming to that required by a particular multimedia standard (e.g. MPEG-2, AVI, etc.). In the present embodiment, the predetermined format of commercial position data 72 is not one recognized as conforming to an MPEG-2 bitstream. Thus, encoding module 74 is used to convert the commercial position data 72 into an MPEG compliant elementary stream, such as formatted commercial position data stream 76 which may be a packetized elementary stream consisting of packetized elementary stream (PES) packets. Accordingly, the commercial indicator, represented by commercial position data 72, is formatted into commercial position data stream 76.

FIG. 4 depicts an exemplary system for combining, or multiplexing, the commercial position data stream 76 into a hybrid multimedia stream. A multiplexing module, herein MUX 78, accepts inputs of video stream 64, audio stream 66, private data stream 68 as well as the formatted commercial position data stream 76 as output by encoding module 74 in FIG. 3. MUX 78 operates to multiplex, encode, or otherwise combine streams 64, 66, 68, and 76 into a single hybrid multimedia stream 80.

Hybrid multimedia stream 80 may then be stored as a file on any type of mass storage system such as a hard drive, floppy drive, optical drive, optical media, tape, etc. Alternatively, the file may be transmitted across a network to a remote host having a module configured to manipulate hybrid multimedia stream 80. For example, multimedia playback module 39, located within computer system 12, may be enabled to read hybrid multimedia stream 80 from the attached mass storage 48.

While the embodiment of FIG. 4 depicts data streams 68 and 76 as separate data streams, in some embodiments, the data within data streams 68 and 76 may be encoded into a single stream. For example, MUX 78, or other circuitry or software upstream of MUX 78, may combine private data stream 68 and formatted commercial position data stream 76 into a single data stream. Therefore, for example, title information data, closed captioning data, and commercial position data may coexist within the same elementary stream. Additionally, while the embodiment of FIG. 4 is depicted as existing separately, the system may be included as part of another executable module, such as, but not limited to, commercial detection module 38, playback module 39, multimedia editing module 40, or multimedia processing module 41.

As defined herein, hybrid multimedia stream 80 includes data representing a multimedia signal as well as data representing commercial information. A multimedia signal includes a video signal and/or an audio signal. The hybrid multimedia stream 80 may also include other types of elementary data streams such as, for example, data stream 68. Thus, while FIG. 4 depicts all four of video stream 64, audio stream 66, data stream 68, and formatted commercial position data stream 76, other embodiments of a hybrid data stream 80 may only contain formatted commercial position data stream 76 and any one of video stream 64 and/or audio stream 66, for example.

Exemplary hybrid multimedia stream 80 is comprised of a plurality of alternating audio data blocks 82, video data blocks 84, private data blocks 86, and commercial position data blocks 88. Audio data blocks 82 represent data from audio stream 66, and video data blocks 84 represent data from video stream 64. Likewise, private data block 86 represents data incorporated from private data stream 68 while commercial position data block 88 represents data originating from formatted commercial position data stream 76.

Audio data blocks 82, video data blocks 84, private data blocks 86, and commercial position data blocks 88 may be encoded in any format and is only limited by the particular standard employed (e.g. MPEG-2, MPEG-4, etc.). For example, the blocks may be in any sequence and each block may vary in size. Accordingly, for example, private data blocks 86 or commercial position data blocks 88 may be placed at the beginning, at the end, or intermittently throughout the hybrid multimedia stream 80.

FIG. 4 also depicts an exploded view of an exemplary commercial position data block 88 which may be embedded within the hybrid multimedia stream 80. Commercial position data block 88 may include fields, such as, but not limited to, a Header Field 90, a Tag ID field 92, a Length Field 94, and a Data Field 96. Commercial position data block 88 may be further encapsulated within a transport packet of a particular multimedia format. For example, commercial position data block 88 may be encapsulated within a packetized elementary stream (PES) packet, as defined by the MPEG-2 standard.

Header field 90 may include subfields useful for decoding and extracting the information from commercial position data block 88. Subfields may include, but are not limited to, the Special ID Subfield 98, Version Subfield 100, Length of the Data Subfield 102, Address of Tag ID Subfield 104, Address of Length Subfield 106, and Address of Data Subfield 108. The information in Header Field 90 may vary by application and the fields described herein are merely examples of one possible format.

The Special ID Subfield 98 may refer to identifying information that a decoder may use to identify commercial position data block 88 as a block containing commercial position data, rather than other types of data which may be stored within a particular data stream. Version Subfield 100 may include information which a decoder could use to determine the format version of the data encapsulated in commercial position data block 88. The Length of the Data Subfield 102 indicates the total length of Data Field 96. For example, the Length of Data Subfield 102 may indicate that Data Field 96 has a total length of 1024 bytes. The Address of Tag ID Subfield 104 indicates the position in data block 88 where the Tag ID field 92 is located. The Address of Data Length Subfield 106 indicates the position in the data block 88 where the Length Field 94 is located. The Address of Data Subfield 108 indicates the position in the data block where the Data Field 96 is located. For example, each of the Address of Tag ID Subfield 104, Address of Data Length Subfield 106, and the Address of Data Subfield 108 may contain a hexadecimal number referencing a specific memory location, or an offset from a predetermined memory location.

Tag ID Field 92 may identify an identifying tag for the commercial position information data. For example, an identifier corresponding to a starting and ending position in the multimedia stream indicating the location of a commercial may be stored under the appropriate tags. Accordingly, Tag ID Field 92 may contain data identifying a “starting position 1” as equivalent to “tag 1,” “ending position 1” as equivalent to “tag 2,” and “starting position 2” as equivalent to “tag 3,” and “ending position 2” as equivalent to “tag 4.” The commercial position identifiers and their tags are not limited to those described above and will vary depending on the type of commercial indicators to be embedded. Furthermore, the identifiers and tags are not limited to any particular order. The commercial identifiers and their identifying tags may, for example, be any series of numbers or letters that can be decoded to identify the commercial indicators in Data Field 96.

Data Field 96 may contain the actual commercial position information data and the associated tag for each tag defined in the “Tag ID” field. For example, in the exemplary embodiment, a commercial indicator corresponding to “starting position 1” may be found by searching sequentially, or otherwise, for the associated “tag 1” within the Data Field 96.

In one embodiment, to assist in searching for a particular tag, and its associated data within Data Field 96, commercial position data block 88 may also include a Length of Data Field 94 which contains the length (e.g. the number of bits) of the commercial position information data associated with a particular tag within Data Field 96.

While the embodiment described above specifically describes embedding a commercial indicator in the multimedia bitstream, it should be understood that embodiments for embedding other commercial information (e.g. information representing characteristics of the multimedia bitstream useful for determining the position of commercial content) may be embedded using the similar techniques.

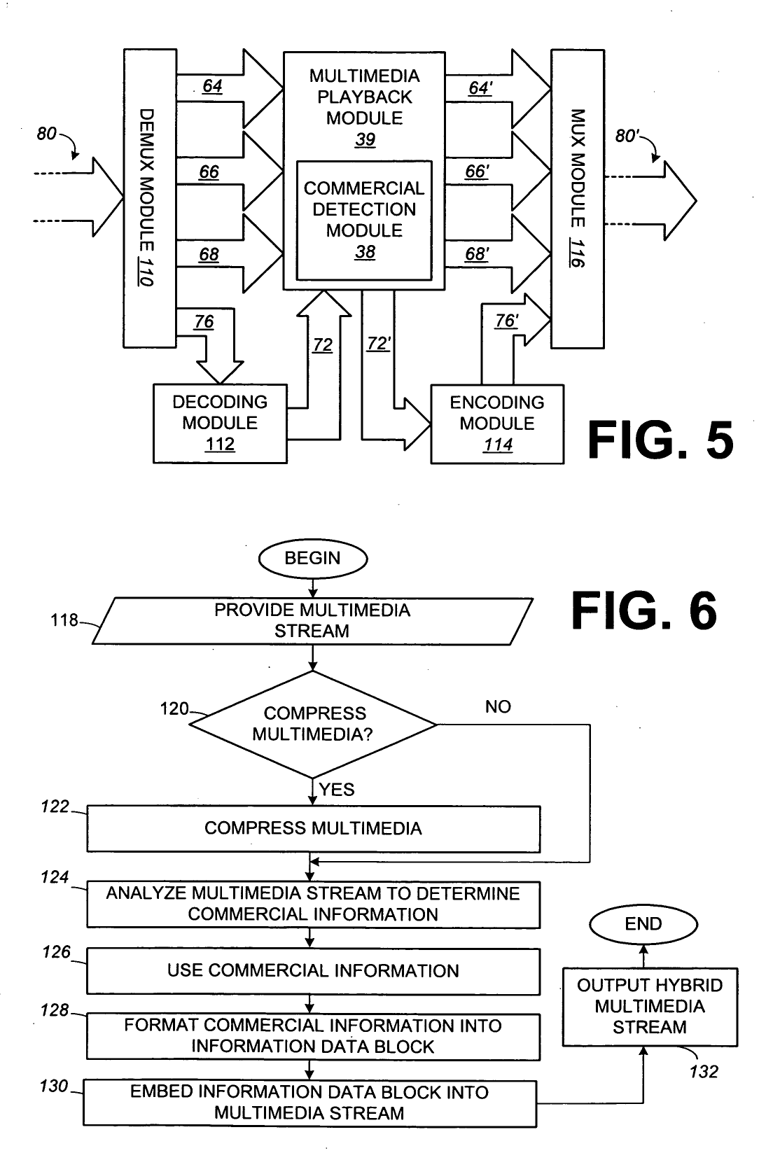

Referring to FIG. 5, another embodiment of a system for embedding commercial information in, and extracting information from, a multimedia bitstream is depicted. The illustrated embodiment includes a demultiplexer, here in DEMUX 110 for demultiplexing, or separating, multimedia streams into elementary streams, a multimedia playback module 39, a commercial detection module 38 for detecting the position of commercials in multimedia content, a decoding module 112 for converting data from a particular multimedia standard (e.g. MPEG-2, etc.) into a format recognizable to multimedia playback module 39, an encoding module 114 for converting data into a bitstream compliant to a particular multimedia standard, and a MUX 116 for multiplexing, or combining, each of the video stream 64′, audio stream 66′, private data stream 68′, and formatted commercial position data stream 76′ into hybrid multimedia stream 80′.

Commercial detection module 38 is configured to operate substantially as described in relation to FIG. 3. In some embodiments, as in the embodiment of FIG. 5, commercial detection module 38 maybe integrated within other executable modules. For example, in FIG. 5, commercial detection module 38 is integrated within multimedia playback module 39.

A user may wish to manipulate the multimedia bitstream by altering the playback based on the position of the commercial content. In general, multimedia playback module 39 performs multimedia playback tasks such as displaying the video content embodied in a multimedia file. Playback module 39 may, in part, manipulate the playback of the multimedia file based on the positions of commercials in a multimedia bitstream. For example, multimedia playback module 39 may be configured to skip over or accelerate the playback speed of portions of the video content corresponding to a commercial.

Playback module 39 may be configured to play content from a different multimedia bitstream in place of the commercial content, and then resume the playback of the original real-time stream once the commercial has ended. This particular feature may be particularly useful if the video content is being played in real-time. For example, during the playback of a live sporting contest, upon detecting a commercial, the playback module may begin playing another sporting contest, or highlights of other sporting contests, in lieu of the commercial content. Based on the end of the commercial, playback module 39 may resume the live sporting contest.

Because it is often preferable to view multimedia content in real-time or on-demand, it is preferable not to wait an extended time for commercial detection module 38 to analyze the multimedia bitstream to detect the position of the commercials in the video content. Additionally, once the commercial indicators have been determined, it is preferable not to reanalyze the multimedia bitstream when this information is needed again. Accordingly, commercial indicators and/or the information used to determine the commercial indicators, may be embedded in the multimedia bitstream, and subsequently extracted by multimedia playback module 39 (or other executable modules), such that complex analysis is not required, or is substantially reduced.

In addition to multimedia playback module 39, other executable modules such as, but not limited to, multimedia editing module 40 and multimedia processing module 41 (FIG. 1), may also use commercial information, such as the commercial indicators, to manipulate a multimedia bitstream. These modules may also be configured to embed commercial information in, and/or extract commercial information from, a multimedia bitstream.

In general, multimedia editing module 40 performs multimedia editing tasks which may, in part, be based on the commercial positions in a multimedia bitstream. Commercials may signify the end of a scene. Accordingly, during the process of editing video content, a user may command the multimedia editing module to automatically detect the commercial content in the multimedia content to assist in organizing the movie for editing. For example, multimedia editing module 40 may be configured to remove portions of the multimedia content corresponding to commercials or replace commercial content with other audio and/or video content. The multimedia editing module may split the multimedia bitstream into separate bitstreams defined by the commercial positions.

Thus, multimedia editing module 40 may, among other multimedia editing tasks, be configured to read in a commercial indicator determined from commercial detection module 38 and perform multimedia editing tasks based on this commercial indicator.

Additionally, multimedia processing module 41 may, among other multimedia processing tasks, be configured to read in a commercial indicator determined from commercial detection module 38 and perform multimedia processing tasks based on this commercial indicator.

For example, multimedia processing module 41 may be used to compress a multimedia bitstream. In some instances, because increased compression may decrease the quality of video and audio content, it may be preferable to compress positions of the multimedia bitstream corresponding to commercial content more than portions corresponding to non-commercial content. Accordingly, multimedia processing module 41 may use the commercial indicator to assist in compressing the multimedia bitstream corresponding to particular portions of the multimedia content.

Executable modules, such as multimedia editing module 40 and multimedia processing module 41, may also be configured to embed information obtained from analyzing the multimedia bitstream and/or information related to the editing or processing performed on the video and/or audio content. For example, multimedia processing module 41 may perform processing steps such as compressing the multimedia bitstream, normalizing the volume of an audio bitstream, changing the contrast or brightness level of a video bitstream, changing the color saturation of a video bitstream, speeding up or slowing down the playback of the bitstream, or other video processing tasks such as enhancing or blurring the video content. When performing processing tasks, multimedia processing module 41, or other executable modules, may perform analysis on the multimedia bitstream. The results of the multimedia processing analysis may be useful for detecting commercial positions in later analysis. For example, to compress the multimedia bitstream, motion analysis may be performed on the multimedia bitstream. The results of the motion detection analysis may also be embedded in the bitstream. Accordingly, the results of the motion detection analysis may be later extracted by commercial detection module 38 in an effort to reduce the repeated analysis of the multimedia bitstream when determining commercial indicators.

While FIG. 5 depicts DEMUX 110, MUX 116, decoding module 112, and encoding module 114 as separate modules, it should be understood that each of these modules may be incorporated within multimedia playback module 38. Additionally, as in the embodiments of FIGS. 3 and 4, multimedia stream 80 may be in a variety of multimedia formats and may undergo a variety of pre-processing steps which are not shown. For example, the multimedia stream may be captured in a first format and converted into another format, which may also involve compression of the video and/or audio data.

In some embodiments, a demultiplexer, DEMUX 110, separates hybrid multimedia stream 80 into individual elementary streams such as video stream 64, audio stream 66, private data stream 68, and formatted commercial position data stream 76. Commercial position data stream 76, which may include a plurality of commercial position data blocks 88, is passed through decoding module 112. Decoding module 112 is configured to decode the data stored within the commercial position data blocks 88, format the data, and pass the data to multimedia playback module 39, which may use the commercial indicators within the data to edit the audio or video within video stream 64 and/or audio stream 66.

Multimedia playback module 39 may request and receive the commercial indicators from commercial detection module 38. In some embodiments, however, multimedia playback module 39 may be configured to directly check the multimedia bitstream for commercial indicators which may have been embedded therein.

If commercial indicators are not embedded within the multimedia bitstream, if the commercial indicators need to be updated, or if different commercial indicators are needed by multimedia playback module 39, then commercial detection module 38 may be configured to provide the appropriate commercial indicators as described in the embodiments of FIG. 3.

Once the commercial indicators are provided by commercial detection module 38, or otherwise extracted from the multimedia bitstream, multimedia playback module 39 may then perform playback functions such as, but not limited to, skipping over the commercial content during playback of multimedia content, based on the commercial indicators.

In the embodiment of FIG. 5, multimedia stream 80 is in the same format of multimedia stream 80 as output from MUX 78 from FIG. 4. Thus, exemplary multimedia stream 80 includes a plurality of alternating audio data blocks 82, video data blocks 84, private data blocks 86, as well as commercial position data blocks 88.

In practice, an executable module is used to decode commercial position data blocks 88 within formatted commercial position data stream 76. For example, decoding module 112 may read the Special ID Field 98 in Header Field 90 to determine whether the particular data block is, in fact, one containing commercial information. If so, decoding module 112 looks to the Version Subfield 100 to determine whether the version of the commercial position data block 88 is known, and therefore able to decode the multimedia data stored within Data Field 96. If decoding module 112 determines that the multimedia data can be decoded, decoding module 112 inspects the contents of Address of Tag ID Subfield 104, Address of Data Length 106, and the Address of Data Subfield 108 to determine the starting address of the Tag ID Field 92, Data Length Field 94 and Data Field 96, respectively.

Decoding module 112 may then jump to the starting address of the Tag ID Field 92, and parse each of the tags and their associated values within Tag ID Field 92, thereby determining the associated tags for the commercial information. In some instances, decoding module 112 may only be interested in a subset of the total information stored in Data Field 96, such as the “starting position 1” and “ending position 1” information. In this example, the decoding module 112 may only parse the Tag ID Field 92 until the module determines that “tag 1” and “tag 2” correspond to the “starting position 1” and “ending position 1” information, respectively.

Decoding module 112 may then jump to the starting address of the Length of Data Field 94. Decoding module 112 may read the contents of the Length of Data Field 94 to determine the length of the commercial position information data associated with each tag for which it seeks information. In this example, decoding module 112 determines the length of the commercial position information data associated with “tag 1” and “tag 2.” For example, Length of Data Field 94 may contain data indicating that the data associated with “tag 1” has a length of 32 bytes, and the data associated with “tag 2” has a length of 64 bytes.

Decoding module 112 may then jump to the start of Data Field 96 and parse through the data contained therein until it finds either “tag 1” or “tag 2,” which may indicate the start of the associated commercial indicator.

Beginning with the tag and reading to an offset address determined from the length of commercial information associated with the tag, decoding module 112 may read and temporarily store the associated commercial information in memory. The executable module then continues parsing the Data Field 96 until finding the remainder of the tags by repeating the step of reading the commercial information associated with each tag.

The resulting decoded commercial position data 72 is output from decoder 112 in a predetermined format. The commercial information, such as a commercial indicator, in the commercial position data 72 may then be passed into multimedia playback module 39 for use in manipulating the multimedia bitstream.

Commercial detection module 38 may perform analysis of the multimedia bitstream that may be useful for a variety of multimedia manipulation tasks. Thus, although this analysis provides information representing characteristics of the multimedia bitstream useful for detecting the position of commercials, the analysis may also be useful for other manipulation tasks. Accordingly, the information from the various analyses may also be saved and encoded back into multimedia stream 80 in a manner similar to that described in relation to FIGS. 3 and 4. This information useful for multimedia manipulation could be encoded into, for example, private data stream 68′ or commercial position data stream 76′, and embedded within hybrid multimedia stream 80′. The hybrid stream 80′ may then be decoded and used by any subsequent executable module configured to extract the multimedia manipulation information from multimedia stream 80′. For example, multimedia processing or editing modules may find this analysis useful for editing or processing the multimedia bitstream.

Once commercial information is embedded within a multimedia stream, the amount of reanalyzing of audio and/or video content to determine the position of commercial content may be lessened or eliminated. By embedding the commercial information within the bitstream, rather than storing it in a separate file for example, the commercial information is not separated from the bitstream. Thus, even if the multimedia bitstream is passed to another computer for further manipulation, the information is available for extraction. By embedding the commercial information in the bitstream itself, the reanalysis of the multimedia stream in subsequent multimedia manipulation steps may be dramatically reduced. For example, rather than reanalyzing the multimedia bitstream, results of previous analyses may be extracted from the bitstream.

FIG. 6 represents an exemplary flow diagram depicting a method for embedding commercial information into a multimedia stream. At step 118, a multimedia file is provided, for example, by a multimedia acquisition module.

Because multimedia files, such as DV files, may be excessively large, it is sometimes beneficial to compress the multimedia bitstream. Thus, at decision block 120, a determination is made as to whether compression of the multimedia information is needed. If compression is needed (the YES condition), the multimedia information is compressed, and possibly converted to a new format, using techniques well known to those skilled in the art in step 122. For example, a DV file may be compressed and converted to MPEG-2, or a bitstream already in MPEG-2 format may be further compressed.

The compression step 122 may also perform analysis of the multimedia bitstream that produces information representing characteristics of the multimedia bitstream that may be useful for detecting a commercial indicator. For example, analysis for video compression may include performing motion estimation. In addition, if desired, analysis other than that needed for the multimedia compression may be performed during compression step 122. The resulting information representing the characteristics of the multimedia bitstream from the analysis performed in compression step 122 may be embedded into the compressed multimedia stream.

Continuing with the flow diagram of FIG. 6, if compression is not performed (the NO condition), or after a bitstream has already been compressed in step 122, the multimedia content may be analyzed in step 124 to determine commercial information. At step 126 the commercial information may be used to manipulate a multimedia bitstream by an executable module. For example, a multimedia playback, editing, or processing module may use a commercial indicator to manipulate the bitstream. At step 128, the commercial information may be formatted into at least one data block. At step 130, the data representing the commercial information is embedded into the multimedia stream, for example, by multiplexing the commercial information with video, audio, and/or data. This stream of data is output in step 132 as a hybrid data stream containing both commercial information and multimedia content, such as video and/or audio data.

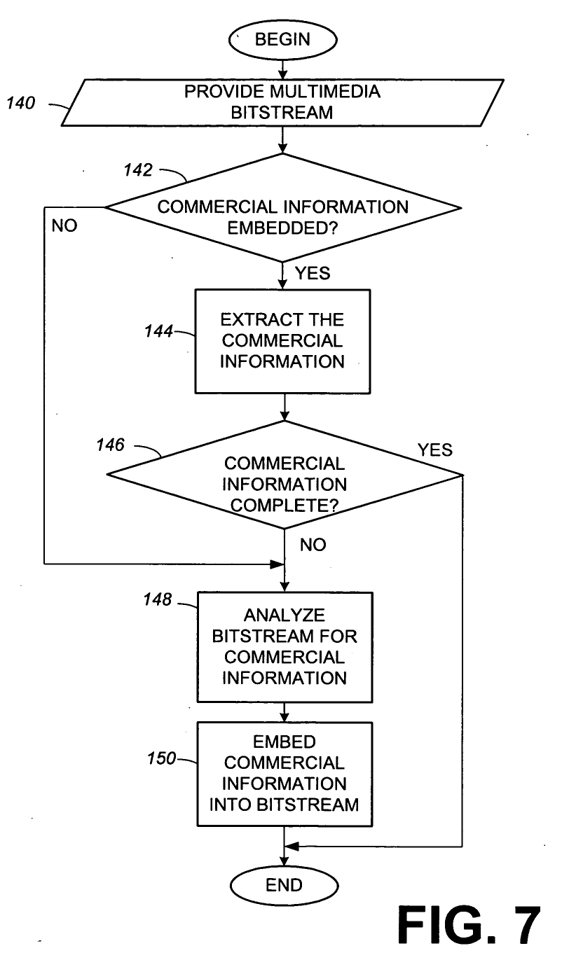

FIG. 7 depicts an exemplary flow diagram representing how a system employing multimedia playback module 39, or other executable modules, might use a hybrid multimedia stream having commercial information embedded therein. At step 140, a multimedia stream is provided which may, or may not, be a hybrid multimedia stream containing commercial information. Accordingly, at decision block 142, a determination is made as to whether any commercial information is already embedded within the provided multimedia stream. This step may also include decompressing, decoding, and/or demultiplexing the multimedia stream.

On the condition that at least some commercial information is embedded in the multimedia stream (the YES condition of decision block 142), the commercial information is extracted in step 144 and a determination is made at decision block 146 whether the embedded commercial information represents all the commercial information that is needed by the multimedia playback module. This determination may be accomplished by merely analyzing the header information of the multimedia data blocks within the hybrid multimedia stream, or by analyzing the commercial information itself.

If all the commercial information that is needed for the multimedia playback module is embedded within the data stream (the YES condition of decision block 146), then the multimedia playback module may then extract and receive the commercial information and use is to manipulate the multimedia bitstream. For example, multimedia playback module may, for example, skip over commercial content corresponding to commercial content identified by commercial indicators during playback.

However, if the necessary commercial information for the executable module is not embedded in the hybrid stream (the NO condition of block 146), the multimedia stream may be analyzed in step 148 to determine and acquire the additional commercial information. For example, in some cases, a commercial indicator in the multimedia bitstream may pertain to only a portion of the subject multimedia bitstream. Accordingly, some additional analysis of the portions not previously analyzed for commercial positions may need to be completed. The multimedia playback module may be configured to use both the commercial information extracted from the hybrid stream and the commercial information discovered from analyzing the multimedia stream in step 148 to manipulate the audio and/or video content.

In contrast to situations in which there is no useful commercial information embedded in the multimedia stream, only the missing information may need to be determined in step 148. Therefore, step 148, which analyzes the multimedia content for commercial content, is potentially less complicated and time consuming than if a full analysis, including all previously performed analysis, is performed.

If decision block 142 indicates that no commercial information is embedded in the multimedia bitstream (the NO condition), the commercial detection module analyzes the multimedia bitstream to determine the commercial information, such as a commercial indicator. The multimedia playback module, or other executable modules, may then use the commercial indicator for manipulating the multimedia content. At step 150, the commercial information, including the commercial indicators, and any information related to the multimedia bitstream analysis performed to detect the commercial indicators, may be embedded into the multimedia bitstream. In addition to embedding commercial information, if the multimedia bitstream was modified, by editing or processing, for example, information related to how the multimedia bitstream was modified may be embedded into the multimedia bitstream.

Once the commercial information is embedded within the multimedia stream, the information may be extracted and used by any executable module, such as, but not limited to, a multimedia playback module, multimedia processing module, or multimedia editing module configured to extract the information from the multimedia data stream.

While the embodiments of FIGS. 6 and 7 may specifically provide examples of embedding commercial indicators into, and/or extracting commercial indicators from, a multimedia bitstream, it should be emphasized that any commercial information may be similarly embedded and extracted. For example, information representing characteristics of the multimedia bitstream that are useful for detecting commercial indicators may also be similarly embedded and/or extracted. Once extracted, the information may be used for a variety of multimedia manipulation purposes.

Embodiments have been described which embed commercial information into the multimedia bitstream by multiplexing a separate, user-defined data stream with multimedia bitstreams. However, some embodiments may embed the commercial information in other ways, and the format of the hybrid stream, or the process used to embed the commercial information to create the hybrid stream, is not limited to any one embodiment.

For example, in some embodiments, commercial information may be directly embedded in the same bitstream as the video and/or audio information. For example, some multimedia formats, such as formats following the MPEG standard, incorporate user defined data, also known as user data, within the video and/or audio bitstreams. User data may contain any binary data and is not necessarily associated with the video or audio information. Accordingly, this user data may, at least in part, correspond to commercial information. This user data, corresponding to commercial information, may be embedded into the bitstream as defined by the particular multimedia format. Similarly, the commercial information may be extracted and used for subsequent multimedia processing, editing, or analyzing.

Additionally, in some embodiments, commercial information may be embedded within multimedia streams that do not specifically allow for embedding user defined data within the multimedia stream. For example, it is possible to add a pattern of bits to a multimedia bitstream without altering the perceivable audio and/or video content. These bits may contain any binary data and are not necessarily associated with the video or audio information. For example, these techniques are used when embedding digital watermarks to identify copyright information in multimedia bitstreams. Accordingly, similar techniques may be used to embed commercial information within these multimedia streams. Just as digital watermarks, for example, can be detected within a bitstream, similar techniques may be used to extract commercial information from the multimedia bitstream. This commercial information may then be used for manipulating the multimedia bitstream by processing or editing, for example.

Accordingly, the above embodiments are merely examples of the many possible ways to embed commercial information within a multimedia bitstream. Similarly, the above embodiments include mere examples of how to extract and use commercial information embedded within a hybrid bitstream. Additionally, it should be emphasized that many variations and modifications may be made to the above-described embodiments. All such modifications and variations are intended to be included herein within the scope of this disclosure and protected by the following claims.

What is claimed is:

1. A method for processing a multimedia bitstream comprising:
providing a multimedia bitstream having multimedia content representing a multimedia signal;
analyzing the multimedia bitstream for characteristics of the multimedia signal useful for determining portions of the video signal corresponding to commercial content;
determining whether at least one of the portions of the video signal corresponds to commercial content based on the characteristics of the multimedia signal useful for determining portions of the video signal corresponding to the at least one commercial;
generating a commercial indicator based on the portions of the video signal corresponding to commercial content; and
embedding the commercial indicator into the multimedia bitstream to produce a hybrid multimedia data stream.

2. The method of claim 1, further including:
extracting the commercial indicator from the multimedia bitstream; and
manipulating the multimedia bitstream based on the extracted commercial indicator.

3. The method of claim 1, further comprising:
embedding information representing characteristics of the multimedia signal useful for determining the commercial indicator in the multimedia bitstream.

4. A method for processing a multimedia bitstream comprising:
providing a multimedia bitstream having multimedia content representing a multimedia signal; and
embedding a commercial indicator within the multimedia bitstream, the commercial indicator signifying commercial content in the multimedia signal.

5. The method of claim 4, further including:
determining the commercial indicator using at least one of the following steps:
analyzing the multimedia bitstream to determine characteristics of the multimedia signal;
extracting the commercial indicator from the bitstream; and
receiving information indicating the portion of the multimedia signal corresponding to the commercial content.

6. The method of claim 5, further including:
formatting the commercial indicator into at least one information data block;
wherein the step of embedding the commercial indicator further includes embedding the at least one information data block into a plurality of multimedia data blocks to produce a hybrid multimedia data stream.

7. The method of claim 4, wherein the step of embedding the commercial indicator includes at least one of the following:
embedding a flag indicating that a portion of a multimedia signal is commercial content;
embedding information representing a start position and an end position in the multimedia signal where a commercial occurs; and
embedding information representing a likelihood that the start and end positions correspond to a commercial.

8. The method of claim 4, further including the step of determining the commercial indicator based on the characteristics of the multimedia signal, the multimedia signal including a video signal;
wherein the step of determining the commercial indicator based on the characteristics of the multimedia signal comprises at least one of the following:
determining an amount of motion in at least one segment of the video signal;
determining if the video signal is interlaced;
determining if the video signal has been altered;
determining if the video signal includes a video watermark;
determining if the video signal has been enhanced;
determining if the video signal has been blurred;
determining the color saturation of the video signal;
determining the contrast level of video signal;
determining the brightness level of video signal;
determining positions of video in which faces or eyes are located;
determining the level of blockiness in the video;
determining frame complexity in the video;
detecting skin colors in the video;
detecting the level of sound associated with the video signal;
detecting whether there is silence associated with the video signal;
detecting animation in the video;
detecting frame orientation in the video;
detecting the audio type associated with the video signal; and
detecting margins in a video frame.

9. The method of claim 4, further comprising:
embedding information representing characteristics of the multimedia signal useful for determining the commercial indicator in the multimedia bitstream.

10. The method of claim 4, further including:
extracting the commercial indicator from the multimedia bitstream; and
manipulating the multimedia bitstream based on the extracted commercial indicator.

11. The method of claim 10, wherein the step of manipulating the multimedia bitstream includes skipping over the commercial content based on the commercial indicator.

12. The method of claim 4, wherein the step of embedding the commercial indicator within the multimedia bitstream includes any one of the following:
multiplexing bits representing the commercial indicator with the content representing the multimedia signal;
embedding bits representing the commercial indicator directly into the multimedia bitstream; or
embedding a pattern of bits representing the commercial indicator into the multimedia bitstream without altering the perceivable multimedia content.

13. The method of claim 4, further including:
extracting information determined from a prior analysis of the multimedia bitstream from the multimedia bitstream; and
analyzing the extracted information to determine the commercial indicator.

14. The method of claim 4, further including:
detecting if the multimedia bitstream contains an embedded commercial indicator.

15. The method of claim 14, further including:
identifying the commercial indicator in the multimedia bitstream; and
determining if an additional commercial indicator is necessary to manipulate the multimedia bitstream, and wherein upon determining the additional commercial indicator is necessary to manipulate the multimedia bitstream, acquiring the additional commercial indicator.

16. The method of claim 15, wherein upon acquiring the additional commercial indicator, embedding the additional commercial indicator into the multimedia bitstream.

17. The method of claim 14, further including:
identifying the embedded commercial indicator in the multimedia bitstream; and
determining if an additional commercial indicator is necessary to manipulate the multimedia bitstream;
wherein upon determining that the additional commercial identifier is not necessary to manipulate the multimedia bitstream, extracting the embedded commercial indicator.

18. The method of claim 14, and wherein upon detecting that the multimedia bitstream does not contain the embedded commercial indicator, determining the commercial indicator;
wherein the step of embedding the commercial indicator includes embedding the commercial indicator resulting from determining the commercial indicator.

19. The method of claim 14, wherein upon detecting that the multimedia bitstream does contain the embedded commercial indicator, extracting the embedded commercial indicator from the multimedia bitstream.

20. A computer readable medium having a computer program for processing a multimedia bitstream comprising:
a first code segment for providing a multimedia bitstream having multimedia content representing a multimedia signal; and
a second code segment for embedding a commercial indicator within the multimedia bitstream, the commercial indicator signifying commercial content in the multimedia signal.

21. The computer readable medium of claim 20, further including:
a third code segment for determining the commercial indicator; and
a fourth code segment for formatting the commercial indicator into at least one information data block;
wherein the second code segment for embedding the commercial indicator further includes embedding the at least one information data block into a plurality of multimedia data blocks to produce a hybrid multimedia data stream.

22. The computer readable medium of claim 20, further including:
a third code segment for extracting the commercial indicator from the multimedia bitstream; and
a fourth code segment for manipulating the multimedia bitstream based on the extracted commercial indicator.

23. The computer readable medium of claim 20, further including:
a third code segment for detecting if the multimedia bitstream contains an embedded commercial indicator.

24. The computer readable medium of claim 23, further including:
a fourth code segment for extracting the embedded commercial indicator from the multimedia bitstream upon the third code segment detecting that the multimedia bitstream contains the embedded commercial indicator.

25. The computer readable medium of claim 20, further including:
a third code segment for embedding information representing characteristics of the multimedia signal useful for determining the commercial indicator in the multimedia bitstream.

26. A system for processing a multimedia bitstream comprising:
an executable module for embedding a commercial indicator within a multimedia bitstream, the multimedia bitstream including content representing a multimedia signal, the commercial indicator signifying commercial content in the multimedia signal.

27. The system of claim 26, wherein the system further includes:
an executable module for determining the commercial indicator, wherein the executable module determines the commercial indicator by any one of the following:
analyzing the multimedia bitstream to determine characteristics of the multimedia signal;
extracting the commercial indicator from the multimedia bitstream; and
receiving information indicating the portion of the multimedia signal corresponding to the commercial content.

28. The system of claim 26, further including:
an executable module for extracting the commercial indicator from the multimedia bitstream; and
an executable module configured to use the extracted commercial indicator to manipulate the multimedia bitstream.

29. The system of claim 26, further including:
a demultiplexer for separating a data stream having the commercial indicator from a hybrid multimedia bitstream.

30. The system of claim 26, further including:
a multiplexer for combining a data stream having the commercial indicator with the multimedia bitstream to form a hybrid multimedia bitstream.

31. The system of claim 26, further including an executable module for embedding information representing characteristics of the multimedia signal useful for determining the commercial indicator in the multimedia bitstream.

32. A system for processing a multimedia bitstream comprising:
an executable module configured to provide a multimedia bitstream having multimedia content representing a multimedia signal and a commercial indicator embedded therein, and
an executable module configured to extract the commercial indicator from the multimedia bitstream.

33. The system of claim 32, further including an executable module configured to extract information representing characteristics useful to determine commercial indicator from the multimedia bitstream.

34. The system of claim 32, further including:
an executable module for determining an additional commercial indicator, wherein the executable module determines the additional commercial indicator by any one of the following:
analyzing the multimedia bitstream to determine characteristics of the multimedia signal; and
receiving information indicating the portion of the multimedia signal corresponding to the commercial content.

35. The system of claim 34, further including:
an executable module configured to embed the extracted commercial indicator and the additional commercial indicator within the multimedia bitstream.

36. The system of claim 32, further including:
a multimedia manipulation module configured to manipulate multimedia content within the multimedia bitstream using the commercial indicator.

37. A system for processing a multimedia bitstream comprising:
an executable module for extracting information determined from a prior analysis of the multimedia bitstream from the multimedia bitstream;
an executable module for determining a commercial indicator by using the extracted information from the prior analysis; and
an executable module for embedding the commercial indicator in the multimedia bitstream.
